(19) United States
(12) Patent Application Publication
(10) Pub. No.: US 2007/0105529 A1
(43) Pub. Date: May 10, 2007

(54) Cross-charging in a mobile telecommunication network

(75) Inventors: Johan Lundstrom, Pargas (FI); Mikael Jyrki Jaatinen, Turku (FI)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/593,159

(22) Filed: Nov. 6, 2006

Related U.S. Application Data
(63) Continuation of application No. 10/136,347, filed on May 2, 2002.

(30) Foreign Application Priority Data
May 13, 2001 (GB) 0113126.7

(51) Int. Cl. H04M 11/00

(52) U.S. Cl. 455/405

(57) ABSTRACT

A method of reallocating charges relating to one or more connections from a first subscriber 1 of a mobile telecommunications network 1 to a second subscriber 2 of that or a different mobile telecommunications network. The method comprises temporarily linking the accounts of the two subscribers maintained in the or each associated Cost Control Node 9,16, receiving at the Cost control Node 9,16 associated with the first subscriber, real time charging messages according to the CAMEL protocol, and allocating the charging messages to the account of the second subscriber including, if necessary, transferring the charging messages to the Cost control Node 17 associated with the second subscriber.

This application is a continuation of U.S. patent application Ser. No. 10/136,347 filed May 2, 2002, the entire contents of which are incorporated herein by reference.

### FIELD OF THE INVENTION

The present invention relates to cross-charging in a telecommunications network and is applicable in particular, though not necessarily, to the handling of reverse charge or collect calls in a mobile network.

### BACKGROUND TO THE INVENTION

The handling of reverse charge (or collect) calls in traditional telephone networks (PSTN or POTS) is a relatively straightforward procedure. Typically the “calling party” calls to the operator on a freephone number. The operator then calls the “called party” to seek permission for the reverse charge call. Assuming the called party agrees, the parties are connected. Call Detail Records (CDRs), which allow the call to be charged, are allocated to the called party and are sent to a billing system in the called party's home network (a process which may take some time especially where the two parties are connected to different operators and the CDRs must be sent via a clearing house). Any CDRs allocated to the calling party may be marked as relating to a freephone call. Similar procedures are used to handle reverse charge calls in mobile networks for standard subscriber types.

In mobile networks, a pre-paid subscriber who has run out of money on his or her account, and who is unable to recharge the account, may wish to make a reverse charge call. In addition, a calling party may wish to call a mobile subscriber (pre-paid or otherwise) who is currently roaming outside of his home network or in a foreign network. This would normally require the called party to pick up the cost for the roaming part of the call. If the called party is unwilling or unable to do this (e.g. because the called party is a pre-paid subscriber with no credit in his account), a reverse-reverse charge situation arises where the calling party is asked to accept the total cost including the roaming part. Whilst it may be possible to handle these scenarios with the conventional reverse charge procedure, the need for a human operator is time consuming not only for the operator but also for the called and calling parties. In the case of a prepaid subscriber having no calling credit, the repeated need for intervention by a human operator may be particularly inconvenient.

This particular problem may be mitigated by introducing the playing of pre-recorded or computer generated voice announcements to the called or calling party. However, this may be ineffective where the parties are in different countries, and one party does not understand the language of the announcement. Moreover, it does not necessarily solve the problem where the party responsible for paying for the call is a pre-paid subscriber and no mechanism exists for relaying the necessary information to the pre-paid account controller (unless the network supports sophisticated ISUP based mechanisms for sending charging information to the originating end of the connection, and further to the pre-paid control system), i.e. it is not possible for the pre-paid account controller to receive and take account of CDRs relating to the reverse charge.

The reverse charging mechanisms described above require that the provider of the (reverse charge) service have a commercial relationship with both the originating network and the terminating subscriber. In practice, this means that the possible destinations that can be called using a reverse charge procedure are limited.

### SUMMARY

The European Telecommunications Standards Institute (ETSI) has standardised a mechanism referred to as Customised Applications for Mobile network Enhanced Logic (CAMEL) for use in mobile networks. CAMEL is intended primarily for pre-paid subscribers and provides for real time charging. A central feature of CAMEL is the provision in each mobile network of at least one Cost Control Node which maintains details of the accounts of all subscribers of that network. CAMEL provides for the transfer of charging related information in real time between a Cost Control Function (CCF) implemented at the Cost Control Node (CCN) (located in a subscriber's home network) and a Service Switching Function (SSF) typically running at, or associated with, an MSC or GMSC (in the case of a GSM network) with which a subscriber to be charged is registered. The SSF may be located in the same network as the CCF or in a different (foreign) network. A protocol known as the CAMEL Application Part (CAP) protocol has been defined for the purpose of transporting CAMEL messages between a CCF and a SSF. Enhancements have and will be made to CAMEL and CAP.

According to a first aspect of the present invention there is provided a method of reallocating charges relating to one or more connections from a first subscriber of a mobile telecommunications network to a second subscriber of that or a different mobile telecommunications network, the method comprising:
temporarily linking the accounts of the two subscribers maintained in the or each associated Cost Control Node;
receiving at the Cost Control Node associated with the first subscriber, real time charging messages according to a charge control protocol; and
allocating the charging messages to the account of the second subscriber including, if necessary, transferring the charging messages to the Cost Control Node associated with the second subscriber.

The present invention is applicable to calls made between the first and second subscribers. These calls may be for example voice calls or data calls. The invention may also be applied to calls between the first subscriber and other parties.

The step of temporarily linking the accounts of the two subscribers may be carried out on a per connection basis. For example, the accounts may be linked following the sending of a request from the first subscriber to the second subscriber, and the acceptance of the request by the second subscriber. The first subscriber may be the calling party, in which case the charging messages relate to the entire cost of the connection. Alternatively, the first party may be a called party who is roaming in a foreign network, in which case the charging messages relate to the roaming part of the connection. Other charging message covering the cost of the connection from the calling party to the home network of the first party are sent to the Cost Control Node associated with the second party and charged to his account in the usual way.

The step of linking the accounts of the two subscribers may be carried out for a fixed period of time. For example, the accounts may be linked for one day or one week during which all or some of the charges incurred by the first subscriber are charged to the second subscriber's account. Accounts may also be linked for a predefined number of connections. Additionally, use of a linked account may be restricted to only certain destinations, e.g. for calls to destinations within a predefined “Friends&Family” group. In the linking procedure, it may also be possible to specify which destinations are allowed.

The charge control protocol defining the real time charging messages may be the CAMEL Application Part (CAP) protocol. Where the network is a SIP based network, a suitable protocol is DIAMETER.

Where the or each mobile network is a GSM network, USSD signalling messages may be used to handle requests for the reallocation of charges, and the response to such requests. It is also possible to use Short Message Service (SMS) messages instead of USSD messages. In this case, the billing and/or prepaid system should make it possible for SMS messages relating to a reverse charge procedure to be sent free-of-charge in order to invoke the charge reallocation procedure.

In one embodiment, a request for the reallocation of charges is sent by the first subscriber to his allocated Cost Control Node. If the second subscriber is associated with the same Cost Control Node, that Cost Control Node may send the request to the second subscriber. If the second subscriber is associated with a different Cost Control Node, the request may be sent to the second subscriber via that second Cost Control Node. The response of the second subscriber may be sent to the common Cost Control Node, or to the Cost Control Node associated with the first subscriber via the Cost Control Node associated with the second subscriber.

According to a second aspect of the present invention there is provided a Cost Control Node for use in a mobile telecommunications network and comprising means for maintaining subscriber accounts, the Node being arranged to receive real time charging information in respect of subscriber's whose accounts the Node holds, the Node further having means for linking the accounts of two or more subscribers, or for linking the account of one subscriber to an account of another subscriber whose account is held by another Cost Control Node, in order to reallocate received real time charging messages.

### BRIEF DESCRIPTION OF THE DRAWINGS

FIG. 1 illustrates schematically a mobile telecommunication network;

FIG. 2 illustrates signalling in the network of FIG. 1 relating to a reverse charge call;

FIG. 3 is a flow diagram illustrating a method of setting up a reverse charge call in the network of FIG. 1; and

FIG. 4 illustrates schematically a scenario where two subscribers having different home mobile networks are involved in a reverse charge call.

### DETAILED DESCRIPTION OF CERTAIN EMBODIMENTS

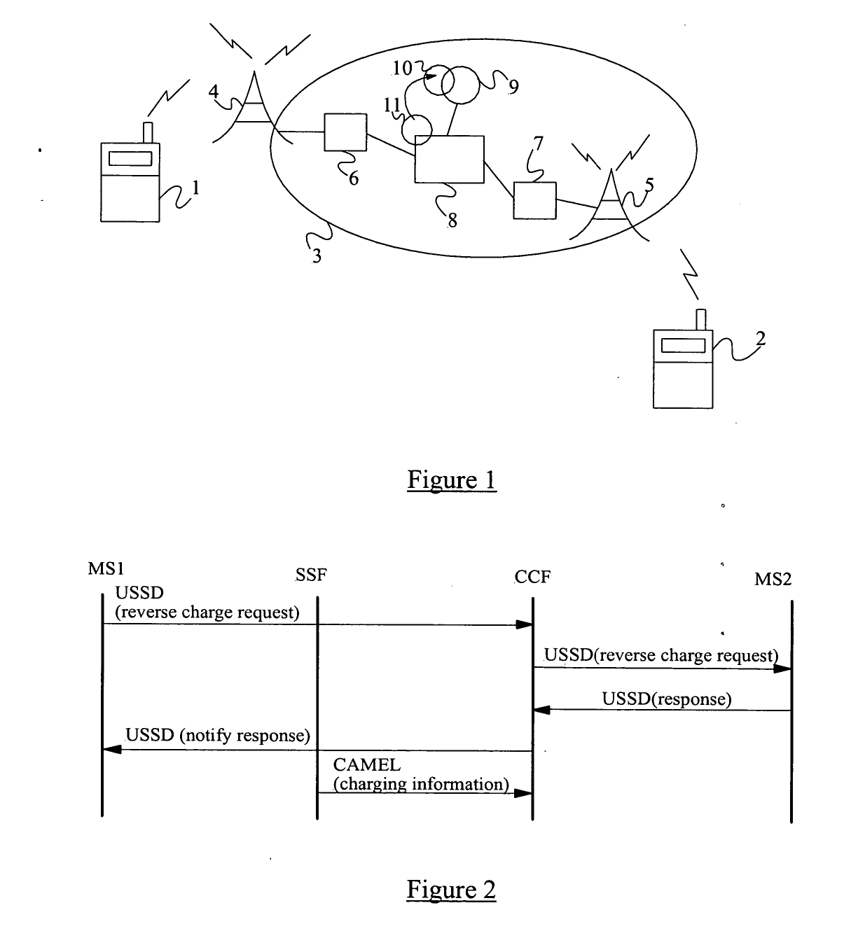

In FIG. 1 there is illustrated a pair of mobile telephones 1,2 which belong to respective subscribers of a mobile telephone network 3 (the “home” network for the two subscribers). The network comprises Base Stations (BSs) 4,5 which provide the radio interface for the network to subscriber telephones, Base Station Controllers (BSCs) 6,7 which control respective sets of BSs, and one or more Mobile Switching Centres 8 (MSCs) which handle the routing of calls to and from mobile telephones.

Coupled to the MSC 8 illustrated in FIG. 1 is a Cost Control Node (CCN) 9. The CCN 9 maintains accounts for subscribers of the network 3. These subscribers may be pre-paid subscribers (in which case the accounts record the current credit of the subscribers), or may be post-paid subscribers (in which case the accounts record the balance owed by the subscribers). Alternatively, the accounts may be for both pre-paid and post-paid subscribers. A CCF 10 implemented at the CCN communicates with Service Switching Functions (SSF) implemented at nodes of the network (or of other networks) where chargeable events can be monitored. FIG. 1 illustrates one such SSF 11 implemented at the MSC 8. The CCF communicates with SSFs using the CAMEL protocol. For example, the CCF 10 may send charging elements to a SSF 11 during the initiation of a connection in order to allow the SSF 11 to run an Advice of Charge (AoC) function to notify a caller of incurred charges during and after a call. A SSF may return charging information relating to a connection to the CCF 10, including call duration, origin, destination (and data volume in the case of a data call).

The GSM system specified by ETSI (GSM 02.90) includes a so-called Unstructured Supplementary Service Data (USSD) protocol which provides for the sending of USSD messages containing some unspecified content over a signalling channel. Typically, the start of a USSD message is identified by a “*” whilst the end of a USSD message is identified by a “#”. USSD is generally a free service within GSM networks. The “USSD Callback” is an example of a service which uses USSD and which allows prepaid subscribers to make calls while roaming abroad, without using the CAMEL mechanisms. In the case of USSD Callback, a subscriber contacts his/her home network using USSD signalling. The home network will then establish a call to the subscriber, and after that establish a call to a wanted destination and link the calls together.

FIG. 1 illustrates a scenario in which a first subscriber using the telephone 1 wishes to make a voice call to a second subscriber using the telephone 2, and the first subscriber wishes to reverse the charges. Using a preconfigured menu of the telephone 1, the first subscriber selects a reverse charge option, and is prompted to enter the phone number of the party to be called (the second subscriber). Upon entry of this number, the telephone 1 causes a USSD message, containing a code identifying the message as a reverse charge request and the telephone number of the second subscriber, to be sent to the network 3. The message is received at the MSC 8, which recognises that the destination for the message is the CCN 9. The MSC 8 forwards the USSD message to the CCN 9.

Upon receiving the USSD message, the CCF 10 at the CCN 9 determines that the number contained in the message belongs to a subscriber for which the network 3 is the home network. The CCF then generates a second USSD message containing a code identifying the message as relating to a reverse charge call, and the telephone number of the first subscriber (the message also includes a “job” number identifying the message to the CCN). This USSD message is sent to the second subscriber via the MSC 8. Upon receiving this second USSD message, the telephone 2 is triggered to display a message notifying the second subscriber of the reverse charge request and the identity of the first subscriber. An options menu is also displayed: 1. Accept; 2. Reject.

If the second subscriber chooses to reject the request, a USSD message is generated containing the appropriate message identification code, the job number, and a reject flag. The message is sent to the CCF 10 at the CCN 9, which generates a further USSD message which is sent to the first subscriber's telephone 1 to notify him of the rejection. The job is cancelled in the CCF 10. If on the other hand, the second subscriber chooses to accept the call, the telephone 2 generates an appropriate USSD message and returns this to the CCF 10. Upon receipt of this message, the CCF 10 causes the account of the first subscriber to be linked to that of the second subscriber. More particularly, the CCF associates the first subscriber with the account of the second subscriber. The CCF 10 then generates a USSD message and sends it to the telephone 1 of the first subscriber, notifying him that the reverse charge request has been accepted, and the call can proceed (a “Continue with call” option may be presented to the subscriber). The call connection between the first and second subscribers is set up in the usual manner.

As far as the SSF 11 implemented at the MSC 8 is concerned, the call is being charged to the first subscriber. CAMEL charging messages generated during and after the call are generated by the SSF 11 and are allocated to the first subscriber, before being sent to the CCF 10 at the CCN 9. At the CCF, charging messages received from the SSF 11 are observed to be allocated to the first subscriber (the messages contain the IMSI of the first subscriber). The CCF 10 has been configured by the reverse charge setup operation to map these charges to the account of the second subscriber, rather than that of the first subscriber. The second subscriber's account is debited accordingly. Following termination of the connection, and following the receipt of all charging messages from the SSF 10, the link between the subscribers'accounts at the CCF 10 is removed.

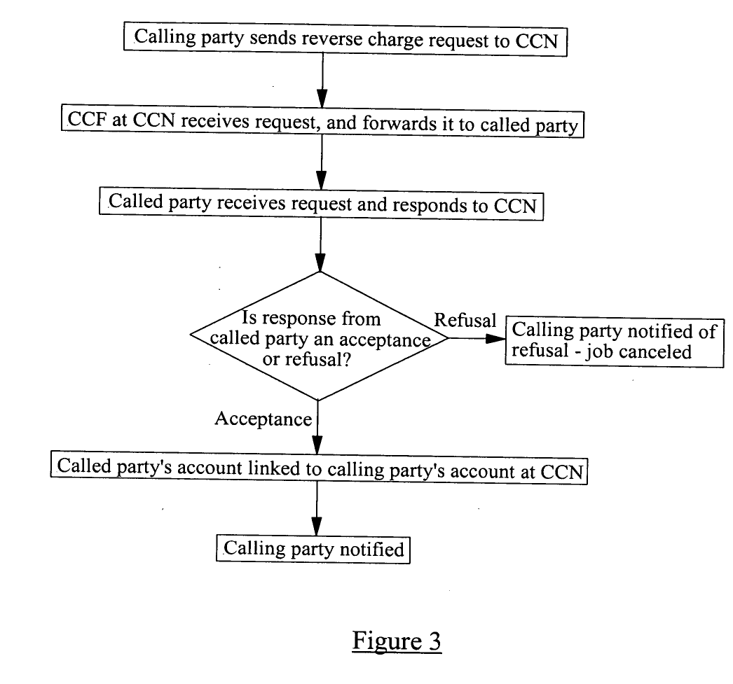

FIG. 2 illustrates the exchange of signalling between the telephones 1,2 and the network 3 in the method described above. FIG. 3 is a flow diagram further illustrating the method.

Using a procedure similar to that described above, a first subscriber of the network 3 may authorise charges incurred by another subscriber to be incurred to the first subscriber's account. USSD messages may again be used for this purpose. The instructing USSD sent from the first subscriber to the CCF of the CCN may specify a fixed time period, number of calls, cost, etc for the reallocation.

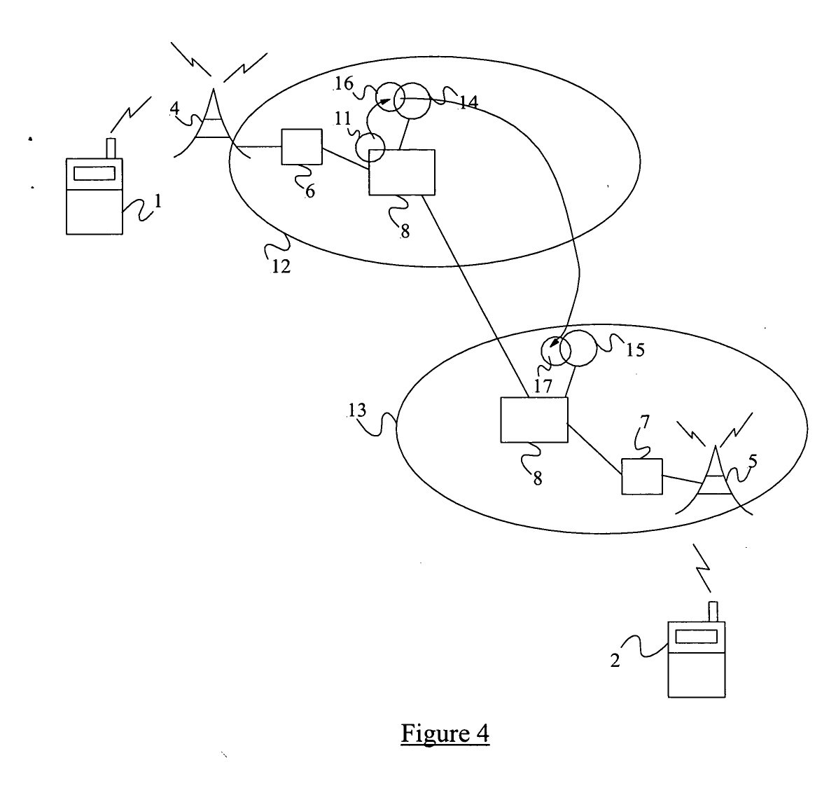

FIG. 4 illustrates a scenario in which the first and second callers to which a reverse charge request relates, belong to different home networks 12,13. Each network 12,13 comprises a CCN 14,15 implementing a CCF 16,17. In this scenario, it is necessary to exchange USSD messages between the two CCFs. Thus, for example, when a USSD containing a request for a reverse charge call (to the second subscriber) is received at the CCN 14 associated with the first subscriber 1, that CCN forwards the message to the CCN 15 associated with the second subscriber 2 which in turn notifies the second subscriber. Assuming that the second subscriber accepts the request, the first CCN 14 is configured to forward subsequent CAMEL charging messages to the CCF 17 at the second CCN 15.

One further point of note is that Call Detail Records (CDRs) are normally generated for CAMEL calls. However, in the case of prepaid subscriptions, these CDRs are not used for billing. The reason why CDRs are generated for prepaid subscribers is that the CDRs are needed for trend analysis, statistics, to answer customer complaints, etc. In the case of a CAMEL call for which a CDR is generated, the CCN has a possibility to insert data in the CDR, by sending a FurnishChargingInformation message to the MSC/SSF. This feature may be useful, e.g. where the calling subscriber has activated the cross-charging function and makes a call. In this case an indication is needed in the generated CDR that the calling subscriber shouldn't be charged/billed for the call. This is important where the calling subscriber does not have a prepaid subscription.

It will be appreciated by the person of skill in the art that various modifications may be made to the above described embodiments without departing from the scope of the invention.

1. A method of reallocating charges relating to one or more connections from a first subscriber of a mobile telecommunications network to a second subscriber of that or a different mobile telecommunications network, the method comprising:
temporarily linking the accounts of the two subscribers maintained in the or each associated Cost Control Node;
receiving at the Cost Control Node associated with the first subscriber, real time charging messages according to a charge control protocol; and
allocating the charging messages to the account of the second subscriber including, if necessary, transferring the charging messages to the Cost Control Node associated with the second subscriber.

2. A method according to claim 1 and comprising linking the accounts of the subscribers following the sending of a request from the first subscriber to the second subscriber, and the acceptance of the request by the second subscriber.

3. A method according to claim 1 and comprising linking the accounts of the two subscribers for a fixed period of time, a fixed number of calls, up to a maximum cost limit, or for only certain call destinations.

4. A method according to claim 1, wherein the step of temporarily linking the accounts of the two subscribers is carried out on a per connection basis.

5. A method according to claim 1, wherein said charge control protocol is CAP.

6. A method according to claim 1, wherein the or each mobile network is a GSM or UMTS network, and USSD signalling messages are used to handle requests for the reallocation of charges, and the response to such requests.

7. A method according to claim 1, wherein SMS messages are used to handle requests for the reallocation of charges, and the response to such requests.

8. A method according to claim 1, wherein said network is a SIP based network, and said charge control protocol is DIAMETER.

9. A method according to claim 1, wherein a request for the reallocation of charges is sent by the first subscriber to his allocated Cost Control Node and, if the second subscriber is associated with the same Cost Control Node, that Cost Control Node sends the request to the second subscriber.

10. A method according to claim 1, wherein the second subscriber is associated with a different Cost Control Node, and the reverse charge request is sent to the second subscriber via that second Cost Control Node.

11. A Cost Control Node for use in a mobile telecommunications network and comprising means for maintaining subscriber accounts, the Node being arranged to receive real time charging information in respect of subscriber's whose accounts the Node holds, the Node further having means for linking the accounts of two or more subscribers, or for linking the account of one subscriber to an account of another subscriber whose account is held by another Cost Control Node, in order to reallocate received real time charging messages.
